(19) United States
(12) Patent Application Publication
(10) Pub. No.: US 2008/0315986 A1
(43) Pub. Date: Dec. 25, 2008

(54) Use of Local User Interface in a Signal Processing Device

(76) Inventors: Carolynn Rae Johnson, Indianapolis, IN (US); Michael Joseph McLane, Indianapolis, IN (US); Darrel Wayne Randall, Danville, IN (US)

Correspondence Address: Joseph J. Laks;Thomson Licensing LLC, 2 Independence Way, Patent Operations, PO Box 5312, PRINCETON, NJ, 08543, US

(21) Appl. No.: 11/885,143

(22) PCT Filed: Feb. 28, 2005
(86) PCT No.: PCT/US2005/006047

§ 371 Date: Aug. 27, 2007

(51) Int. Cl. G05B 23/02

(52) U.S. Cl. 340/3.71

(57) ABSTRACT

The present invention provides a method and system of controlling a plurality of signal processing devices from a first signal processing device, wherein the first signal processing device generates a signal representing an on-screen display, including enabling an on-screen display associated with a user interface for one of the plurality of signal processing devices at the first signal processing device, selecting a control feature of one of the plurality of signal processing devices and providing feedback at the user interface of one of the plurality of signal processing devices associated with the selected control feature.

### FIELD OF INVENTION

The present invention relates to using a signal processing device to distribute a received signal to multiple signal processing devices and in particular, to control of remote signal processing devices from a local signal processing device co-located with the signal processing device that receives and distributes the received signals.

### BACKGROUND OF THE INVENTION

Current products that distribute signals received at one signal processing device (physical unit) to two signal processing devices are designed so that the physical unit decodes a signal, e.g., a satellite signal and sends that signal to two different (other) signal processing devices, one that is located in the same room (co-located) as the physical unit, and one that can be located elsewhere in the house/structure/building. The two user interfaces could be controlled by the same physical unit, which includes one set of front panel buttons that are by default located at the signal processing device co-located with the physical unit. Therefore, were the user allowed to control a remote second signal processing device via the front panel buttons of the local signal processing device (co-located with the physical unit), the user would be provided with no feedback to indicate the results of the actions taken. Similarly, were the user/viewer provided with a second set of front panel buttons at the local signal processing device to control a remote signal processing device, the user/viewer would still be provided with no feedback to indicate the results of the actions taken.

There is a further need for the user/viewer to be able to distinguish the two user interfaces. However, any naming convention put in place by the manufacturer (e.g. local versus remote, signal processing device TV1 versus signal processing device TV2), will likely have very little meaning to/for the user/viewer. For example, with the naming convention of Remote versus Local, the user/viewer might consider the Local signal processing device to be the one he/she is currently interacting with, while the Remote signal processing device is the one the user is not interacting with, whereas the manufacturer intended Local signal processing device to always refer to the signal processing device co-located with the physical unit and Remote signal processing device to refer to the signal processing device not co-located with the physical unit. Therefore, there is a need for the user to be able to enter his/her own names for the separate user interfaces.

### SUMMARY OF THE INVENTION

The present invention is directed to use of a local user interface of a signal processing device to control remote signal processing devices. The present invention provides a method of controlling a plurality of signal processing devices from a first signal processing device, wherein the first signal processing device generates a signal representing an on-screen display, the method including enabling an on-screen display associated with a user interface for one of the plurality of signal processing devices at the first signal processing device, selecting a control feature of one of the plurality of signal processing devices and providing feedback at the user interface of one of the plurality of signal processing devices associated with the selected control feature. The present invention also includes a system for implementing the above method.

Signal processing devices may include, but are not limited to, set top boxes (STBs), video cassette players and recorders (VCPs and VCRs), digital video disc players (DVDs) as well as televisions (TVs). Typically, a signal processing device that receives and distributes the received signals is, for example, a set top box (STB) also denoted herein as “physical unit” to distinguish it from the local and remote signal processing devices to which the physical unit/signal processing device/STB distributes signals. The local and remote signal processing devices are typically TVs, VCPs, VCRs, DVDs and the like.

### BRIEF DESCRIPTION OF THE DRAWINGS

These and other aspects, features and advantages of the present invention will become apparent from the following detailed description of preferred embodiments, which is to be read in connection with the accompanying drawings.

FIG. 1 is an exemplary embodiment of a signal processing device that receives signals and distributes the received signals to a plurality of signal processing devices.

FIG. 2 is an exemplary display screen for the assisted setup to access to the naming screen feature.

FIG. 3 is an exemplary display screen used for assigning a user selected name to the local signal processing device.

FIG. 4 is an exemplary display screen used for assigning a user selected name to a remote signal processing device.

FIG. 5 is an exemplary display screen for the unlock user interface control feature.

FIG. 6 is an exemplary display screen for the channel changing status and control feature.

FIG. 7 is an exemplary display screen for the unlock status and control feature.

FIG. 8 is an exemplary display screen for the power status and control feature.

### DETAILED DESCRIPTION OF THE PREFERRED EMBODIMENTS

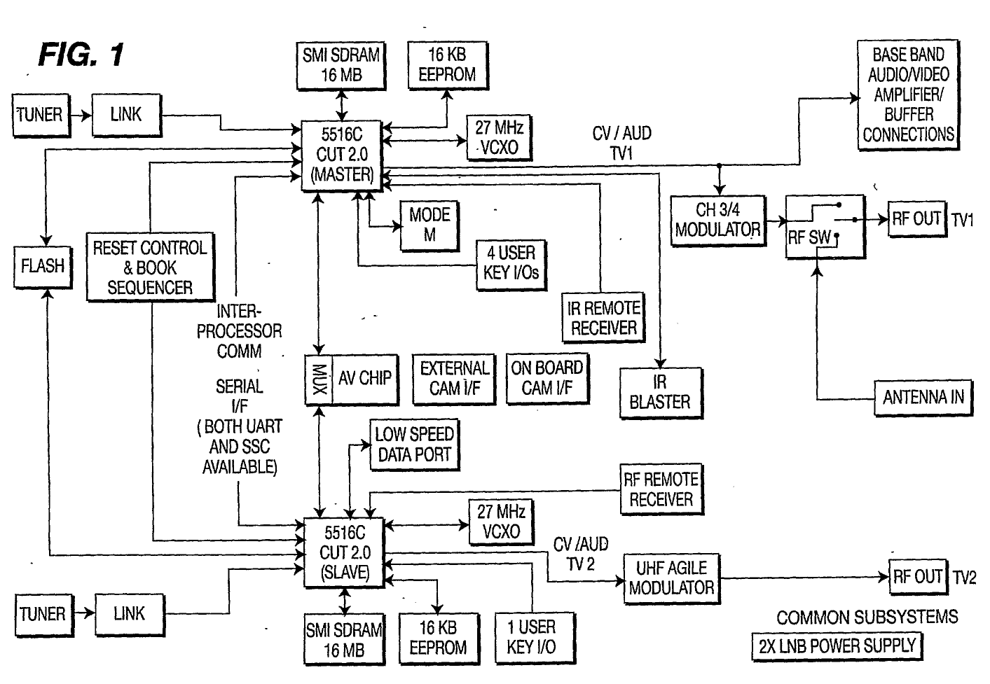

FIG. 1 is an exemplary embodiment of a signal processing device that receives signals and distributes the received signals to a plurality of signal processing devices. Specifically, the signal processing device depicted in FIG. 1 receives a signal and distributes the received signal to a signal processing device co-located with the distributing signal processing device and also to a plurality of signal processing devices not co-located with the distributing signal processing device. The co-located signal processing device is labeled TV1 on FIG. 1. While TV1 may, in fact, be a television, it is not so limited and may be any signal processing device including video cassette players and recorders (VCPs and VCRs), digital video disc players (DVDs) as well as televisions (TVs). The plurality of non-co-located signal processing devices are denoted TV2. While there may be only one non-co-located signal processing device, the present invention is not so limited and there may, in fact, be a plurality of such non-co-located signal processing devices, which may also be any signal processing device including video cassette players and recorders (VCPs and VCRs), digital video disc players (DVDs) as well as televisions (TVs).

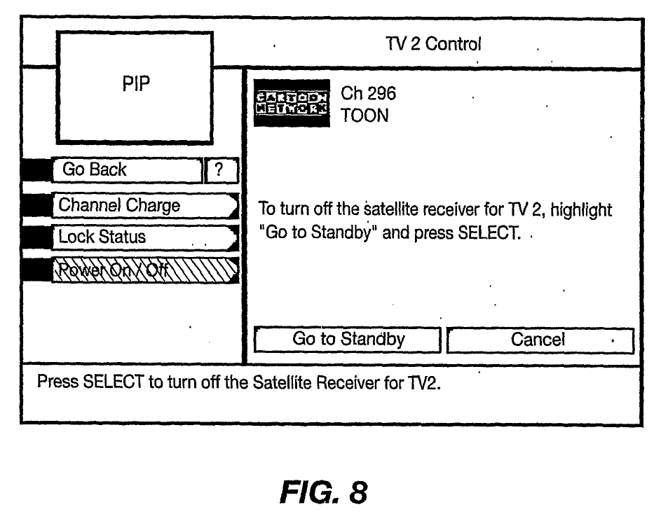

Communications between the distributing signal processing device and the other signal processing devices is standard NTSC analog output. The signal processing device co-located with the distributing signal processing device is connected with RCA jacks or a channel 3/4 modulator. The signal processing device not co-located with the distributing signal processing device is connected through a coax to an agile modulator. The distributing signal processing device depicted in FIG. 8 provides the means for controlling a plurality of signal processing devices from a first signal processing device wherein the first signal processing device generates a signal representing an on-screen display including a means for enabling the on-screen display associated with a user interface for one of the plurality of signal processing devices at the first signal processing device, a means for selecting a control feature of one of the plurality of signal processing devices and a means for providing feedback at the user interface of one of the plurality of signal processing devices associated with the selected control feature.

In many ways, the two user interfaces (UIs) of the system operate as a single system since the two interfaces are controlled by the same physical unit. For example, editing of the channel list set up, rating limits, spending limits, etc, are carried over from one user interface to the other, and purchases and timers are accessible and changeable from both signal processing devices. In other ways, the two user interfaces operate as separate systems. Channel tuning on one unit does not affect the other, and the two UIs maintain some separate settings (e.g. picture size, display options, etc). However, there are some instances in which the user interfaces overlap, but do not operate as one system. For example, the user/viewer/owner has the ability to modify the lock status of either user interface from either user interface. In other words, the user/viewer/owner is able to lock or unlock the UI associated with signal processing device TV2 from signal processing device TV1 without affecting the lock status of signal processing device TV1, and vice versa.

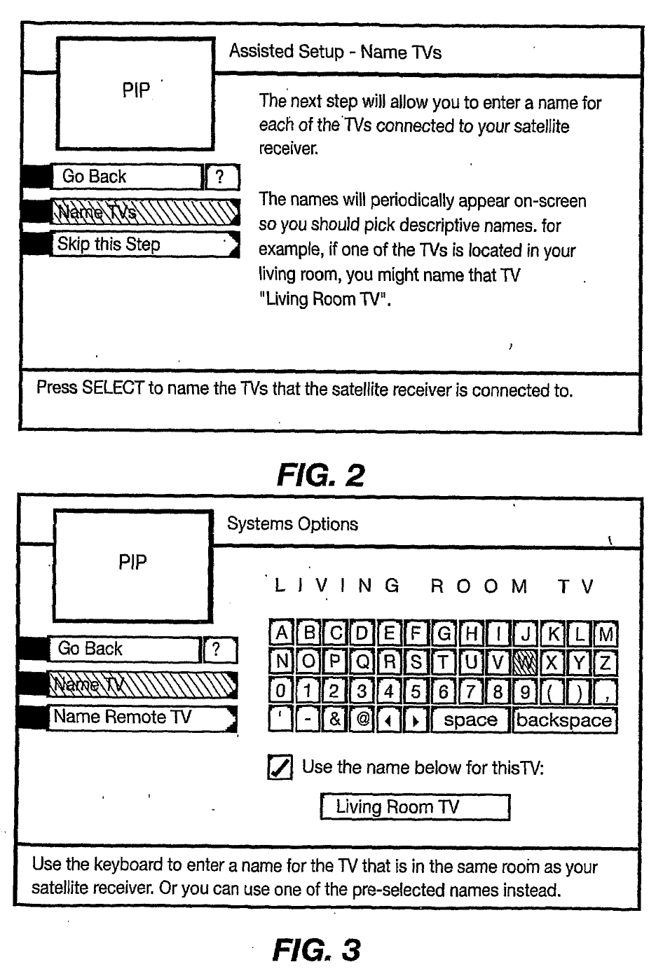

The present invention includes an assisted setup that appears the first time that the signal processing device is powered on. This setup guides the user/viewer/owner through key screens that must be completed prior to accessing the satellite signal, such as dish pointing coordinates, dish type selection and the signal meter. Also included in this assisted setup or as a separate system option, the user/viewer/owner is presented with a screen similar to that seen in FIG. 2, that allows him/her to indicate that he/she wishes to specify a name for each of the two or more user interfaces.

The user/viewer/owner is then presented with screens similar to those in FIGS. 3 and 4 that allow him/her to enter names for these user locations via the on-screen keyboard. The figures depict only two user interfaces but the present invention is not limited to only two interfaces. In addition to allowing the user/viewer/owner to enter his/her own name for each signal processing device, this screen also allows the user/viewer/owner to choose from among several pre-entered/pre-assigned names for faster setup. This is accomplished by placing a check in the check box and using the choice field to select a desired name.

Once the user selected or entered names for the user interfaces/tuners, anytime that the system needed to reference these locations on-screen the names specified by the user/viewer/owner is displayed. This reduces any confusion as to which UI/tuner was being referenced by the system.

In many ways the two user interfaces of the system operate as a single system, since the two interfaces are controlled by the same physical unit. In the present invention the parental controls created by the system user/owner affect what can be viewed on either user interface. In other ways the user interfaces act independently; for example, one user can tune different channels and can access most areas of the menu system without affecting the other user interface. Because separate channels can be tuned on either signal processing device, the two user interfaces can be temporarily unlocked independently of one another, so that the parental controls can be by-passed on one user interface without affecting the other user interface.

This feature of the present invention allows the system owner/user to unlock the signal on the remote signal processing device without the need to be in the physical presence of that signal processing device. For example, if the second/remote signal processing device is located in a child's upstairs bedroom, and the parent wished to unlock that unit so that the child could watch a program that might normally be blocked, he/she is able to do so from the primary/local unit, which might be located in the living room, close to where he/she is already located.

When the user summons/enables the display screen that controls the lock status of the system, rather than merely being presented with an option to unlock the user interface for the signal processing device he/she is currently watching, an additional option allows the user to choose to change the status of a remote interface.

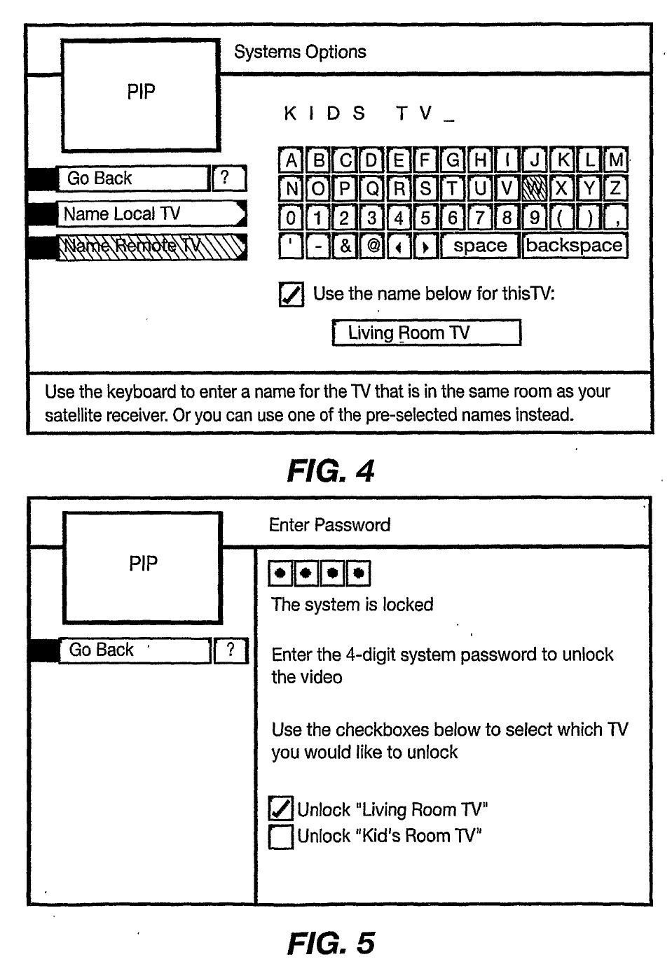

In the example in FIG. 5, the user has previously identified the signal processing devices as “Living Room TV”, which in this example is the user's current location, and “Kid's Room TV”, which is the remote location. When the user selects the unlock control from the “Living Room TV” interface, he/she is presented with a screen similar to that seen in FIG. 5. Since the user is currently in the Living Room, the “Unlock Living Room TV” option is checked by default, and the “Unlock Kid's Room TV” option is unchecked. The user is able to indicate which of the two TVs—or both—should be unlocked simply by checking the appropriate box(es).

Similarly, when the user chooses the relock option from either interface, he/she is presented with an indication of which TVs were unlocked and is given the option to relock any or all unlocked TVs.

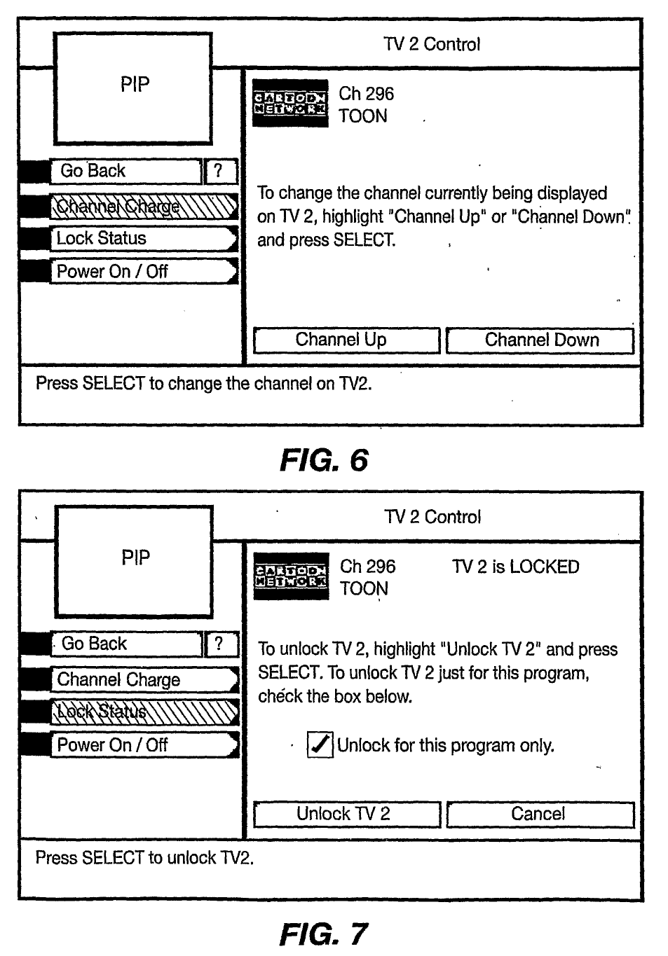

Referring to FIG. 6, from the user interface associated with signal processing device TV1, the user is able to enable/summon a screen to allow for limited control over the user interface and tuner associated with signal processing device TV2. Once that screen is accessed, the user is able to control signal processing device TV2, by making user interface choices from signal processing device TV1 using either the remote control device associated with signal processing device TV1 or the front panel buttons that control only signal processing device TV1 menus.

As can be seen in the example of FIG. 6, the user is provided with feedback as to the currently tuned channel of signal processing device TV2 and is provided with a means to change the channel—via Channel Up and Channel Down UI buttons. An alternative embodiment includes the addition of UI controls for digit entry.

Another option in this menu/display screen of the user interface informs the user of the lock status of the user interface associated with signal processing device TV2 and allows the user to unlock signal processing device TV2—or relock it if it were currently unlocked (see FIG. 7). Yet another menu option allows the user to turn the satellite receiver on or off for signal processing device TV2 (see FIG. 8).

Although not shown, in an alternative embodiment, access to this menu/display screen of the user interface is password protected to limit use of this menu to the system owner, and though this particular implementation is limited to basic control of the second tuner/user interface, additional embodiments could easily add other elements of signal processing device TV2 control to this menu.

In further embodiments, control of other capabilities is provided in the menus/ display screen of the user interface but the menus/ display screen of the user interface described above allows the user to watch programming on any channel. Purchases for pay-per-view systems can be watched by first purchasing them on signal processing device TV1 in the embodiment that is assumed herein above but if this were not the case, pay-per-view purchasing could be added to the capabilities facilitated by the menus/ display screen of the user interface in an alternative embodiment.

Yet another embodiment includes a warning if the user interface of signal processing device TV2 is currently being accessed by a user at the signal processing device TV2 location, or to provide a screen lock function so that this menu cannot be used to alter the lock status of signal processing device TV2 if any screen on signal processing device TV2 has been accessed that can also change the lock status, or cannot be used to change the channel or change the power/active status if a timer is active in signal processing device TV2.

It is to be understood that the present invention may be implemented in various forms of hardware, software, firmware, special purpose processors, or a combination thereof, for example, within a mobile terminal, access point, or a cellular network. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method of controlling a plurality of signal processing devices from a first signal processing device, wherein said first signal processing device generates a signal representing an on-screen display, said method comprising:
enabling an on-screen display associated with a user interface for one of said plurality of signal processing devices at said first signal processing device;
selecting a control feature of said one of said plurality of signal processing devices; and
providing feedback at said user interface of said one of said plurality of signal processing devices associated with said selected control feature.

2. The method according to claim 1, wherein said choices are made using a remote control device.

3. The method according to claim 1, wherein said choices are made via front panel buttons of said first signal processing device.

4. The method according to claim 1, wherein said selected control feature comprises changing a channel of one of said plurality of signal processing devices.

5. The method according to claim 1, wherein a lock status of said user interface of said one of said plurality of signal processing devices is altered.

6. The method according to claim 1, wherein access to a menu of said user interface is password protected.

7. The method according to claim 1, wherein said control feature comprises pay-per-view access for said one of said plurality of signal processing devices.

8. The method according to claim 1, wherein said control feature comprises a warning signal if said user interface of said one of said plurality of signal processing devices is being accessed by a user at said one of said plurality of said signal processing devices.

9. The method according to claim 1, wherein said control feature comprises an active status based on a timer.

10. The method according to claim 1, wherein said control feature comprises altering a channel setup list.

11. The method according to claim 1, wherein said control feature comprises altering rating limits.

12. The method according to claim 1, wherein said control feature comprises altering spending limits.

13. The method according to claim 1, further comprising an assisted setup which permits a user to specify a name for each of said plurality of signal processing devices and said first signal processing device.

14. The method according to claim 13, wherein said user specified name is selected from a pre-defined list of names.

15. The method according to claim 13, wherein user specified name is entered via an on-screen keyboard.

16. The method according to claim 1, wherein said control feature comprises altering said parental controls.

17. The method according to claim 1, wherein said control feature comprises the ability to lock said one of said plurality of signal processing devices.

18. The method according to claim 1, wherein said control feature comprises the ability to unlock said one of said plurality of signal processing devices.

19. A system for controlling a plurality of signal processing devices from a first signal processing device, wherein said first signal processing device generates a signal representing an on-screen display, comprising:
means for enabling an on-screen display associated with a user interface for one of said plurality of signal processing devices at said first signal processing device;
means for selecting a control feature of said one of said plurality of signal processing devices; and
means for providing feedback at said user interface of said one of said plurality of signal processing devices associated with said selected control feature.
